(19) United States
(12) Patent Application Publication
(10) Pub. No.: US 2008/0091297 A2
(43) Pub. Date: Apr. 17, 2008

(54) Method and apparatus for receiving and/or transporting substrates

(75) Inventors: Ralf Tillmann, 68309 Mannheim (DE); Hans-Juergen Maas, 55286 Woerrstadt (DE); Ingo Weiske, 60316 Frankfurt am Main (DE); Martin Kraus, 64572 Buettelborn (DE)

Correspondence Address: DEMONT & BREYER, LLC, 100 COMMONS WAY, Ste. 250, HOLMDEL, NJ, 07733, US

(73) Assignee: Integrated Dynamics Engineering Inc., Randolph, MA (US)

(21) Appl. No.: 11/677,895

(22) Filed: Feb. 22, 2007

(30) Foreign Application Priority Data
Feb. 23, 2006 (DE) 10 2006 008 997.9

(51) Int. Cl. G06F 7/00

(52) U.S. Cl. 700/213

(57) ABSTRACT

The invention relates to a method for receiving and/or transporting substrates, wherein, by means of at least one sensor, a deviation of the position of a substrate, in particular of a substrate arranged in a slot of a container, is detected at least with respect to one degree of freedom and a movement course of at least one receiving device and/or transporting device is determined with the inclusion of said deviation.

### FIELD OF THE INVENTION

The invention relates to a method and an apparatus for receiving and transporting substrates, in particular wafers in the semiconductor industry.

### BACKGROUND OF THE INVENTION

Fabrication processes in the semiconductor industry typically use reproduction methods in which different originals and substrates are used. The originals used in this case comprise both masks which are used in a lithographic process, and stamps for stamping methods. Furthermore, there are writing processes which involve writing directly to the substrates (EBeam). The substrates, in the production of semiconductors, are generally thin wafers (currently up to 300 mm in diameter and less than 1 mm thick) which are produced from a wide variety of semiconductor materials. The masks that are the most frequently used at the present time are produced from square quartz glass cubes (side length of 6 inches) having a thickness of up to ¼ inch. Originals are also referred to as substrates in the methods described below, for reasons of elucidation.

Throughout the fabrication chain, the semiconductor substrates have to be stored securely and as cleanly as possible in closed containers for their transport and for introduction into the various production, process and measurement installations. Said containers are referred to as cassettes or racks. Substrate repositories used with the designations SMIF, FOUP, FOSB, open cassette, etc. are typical in this context, in which up to 25 substrates can be arranged one above another at a defined distance, which is referred to as the pitch. Over the years a wide variety of models, types and standards of racks and cassettes have developed, which all exhibit variations in their geometry. What is also crucial is that each individual rack or cassette may already have tolerances with respect to the reference design on account of the fabrication. For these reasons, the position of the substrates may differ drastically in part (by more than one pitch in terms of height) in comparison over all types of rack. In addition, the substrates may be displaced in the containers by the process of opening the container or by action on the containers, even after the opening thereof.

One requirement made of automation technology in semiconductor fabrication is to fetch the substrates from the containers and to introduce them. The requirements with regard to reliability and freedom from stress for the substrates as they are transferred from container to installation are constantly rising in this case. For this reason, it is necessary for the transfer point to be actuated as accurately as possible. The transfer point itself is generally imparted once by means of so-called teaching processes in automation technology. In the case of containers that receive more than one substrate, likewise only one position is learned and the positions of the substrates arranged thereabove are postulated by means of displacement vectors (typically the position of the individual substrates is derived by way of the pitch). Prior to access, the presence of a substrate is generally determined by means of contactless sensors.

The influence of the above-described tolerances on the position of the substrates given the same types of rack, on the one hand, is covered by a correspondingly sufficient capture range of the automation process. If the intention is to use types of rack with other design data, on the other hand, the associated transfer point has to be learned anew.

This procedure has two fundamental disadvantages. Firstly, the enlarged capture range leads to a loss of time and possibly to increased relative movement at the expected transfer point, whereby stress, damage or contaminations can occur to an increased extent at the substrate. Secondly, the learning of transfer points when using other types of rack likewise leads to complex and time-intensive handling in the automation process.

### OBJECT OF THE INVENTION

Against this background, the invention is based on the object of reducing the above-described disadvantages in the prior art and of improving the receiving and the transporting of substrates, in particular wafers.

In accordance with a further object of the invention, the flexibility of the automation process for different containers is intended to be increased.

A further object of the invention is to reduce tolerance problems at the transfer position and the consequences thereof, which may be caused by differences in different types of container (design specific), deviations in individual containers (individual container specific), deviations of the desired position for the individual slots within a container (individual slot specific), alterations of the substrate position due to external actions (process of opening the container, impacts at the containers, etc.) (individual slot specific) and alterations of the position of adjacent substrates which can have a disadvantageous effect on the process (individual slot environment specific).

A further object of the invention is to reduce the loss of time when setting up and maintaining the installations.

According to a further object of the invention, the intention is to reduce the process time for the automation steps.

### SUMMARY OF THE INVENTION

The object of the invention is already achieved by means of a method for receiving and transporting substrates, and also by means of an apparatus for receiving and transporting substrates, in accordance with one of the independent claims.

Preferred embodiments and developments of the invention can be gathered from the respective subclaims.

Accordingly, a method for receiving and/or transporting substrates is provided, wherein, by means of at least one sensor, a position of a substrate, in particular of a substrate arranged in a slot of a container, is detected at least with respect to one degree of freedom.

The detection of the position of a substrate is understood to mean, in the sense of the invention, both the detection of an absolute position and the detection of a relative position, for instance with respect to other components of an installation within which the method according to the invention is used.

A movement sequence of the receiving and transporting device is determined with the inclusion of the position of the substrate.

The position detection makes it possible to carry out a significantly more accurate handling of the receiving and transporting device. Thus, the receiving device is guided significantly more accurately and the installation can be adapted to different configurations and boundary conditions, in particular different types of container and different substrates.

In accordance with one preferred embodiment of the invention, the relative position of the substrate with respect to a receiving device is determined by means of the at least one sensor. It has been found that an exact positioning is made possible in particular by means of the determination of the distance between the receiving device and the substrate.

In accordance with a further preferred embodiment of the invention, the occupancy of a substrate repository is determined by means of at least one sensor. The occupancy of a substrate repository (rack) is a variable installation-specific parameter, the consideration of which in the fine setting of the movement course enables the receiving device to be guided significantly more accurately. Thus, alterations of the occupancy, for instance empty slots, have effects on the entire substrate repository and hence also on the substrates which have remained in the substrate repository.

In one development of the invention, a position of the substrate and/or the occupancy of a substrate repository is determined by means of at least one sensor arranged on a receiving device.

The inventors have discovered that it is possible, in an automation device known per se, with sensors arranged on the receiving device, both to determine the position of the substrates, in particular the relative position with respect to the receiving device, and to determine whether the slots of a substrate repository (rack) are in each case occupied.

For this purpose, the receiving device travels on an essentially predetermined movement course, as is also the case in installations which are known from the prior art and which do not have corresponding sensors.

An exact relative position of the substrate in relation to the receiving device is determined by means of the sensor or sensors. Said position can then be taken into account in further movement courses in order to set the movement course more accurately.

In a further preferred embodiment of the invention, characteristic data relating to position changes are stored and the movement course of the receiving device is determined with inclusion of said characteristic data.

In particular, provision is made for recording and storing a characteristic data set which relates to specific installation configurations. In this case, learning cycles by means of which the movement course of the receiving device can be finely adjusted can be conducted with an installation under different configurations, for instance with different occupation of a substrate repository or with different substrate repositories and different substrates.

Said characteristic data are then taken as a basis in the form of data sets in an automation device. Depending on the current configuration of the installation, the movement course of the receiving and transporting device is then finely adjusted, with the inclusion of the characteristic data set, without continuous adaptation of the movement sequence being necessary.

In one development of the invention, the movement course may also be adapted to changed installation configurations continuously or at intervals. An automation device advantageously conducts a learning cycle in which the receiving and transporting device follows the slots of a substrate repository, for example, along a predetermined movement direction. Characteristic data of the installation configuration present at this point in time are stored. During operation, the automation device can then be adapted if, for example through removal of substrates, the accurate position of other substrates situated above or below the slot, for example, changes.

The installation thus learns changes in the movement course which correlate with changes in the installation configuration.

In an advantageous manner, both the occupancy of a container with respect to the substrate repository, in particular the occupancy of the individual slots, and the type of the substrate to be moved is taken into account in the determination of the movement course of the receiving device.

In one advantageous embodiment of the invention, the position of the substrate, in particular the relative position with respect to the receiving device, is detected in three translation directions and in at least two rotation directions. An accurate position determination is thus possible in the case of a round wafer. As long as the wafer has not yet been processed, a determination of the position in two rotation directions suffices on account of the rotational symmetry.

In one preferred embodiment of the invention, the position is detected by means of at least two sensors arranged on the receiving device. Sensors of this type, for example configured as capacitive distance sensors, make it possible, if they are arranged at a defined distance from one another, to accurately determine the relative position of the wafer with respect to the receiving device.

In particular, provision is made for positioning a plurality of sensors on the receiving device. By means of such a sensor array extending over the substrate on the edge side, it is possible, since not all of the sensors are covered by the wafer, to detect the accurate position of the wafer with regard to the wafer level with respect to the receiving device.

The invention furthermore relates to an apparatus for receiving and transporting substrates, which has at least one sensor for detecting the position of a substrate at least with respect to one degree of freedom, in particular of a substrate arranged in a slot of a container (rack).

The apparatus furthermore has means for controlling the movement course of a receiving and transporting device. Said control means are, in particular, parts of an automation device. According to the invention, said means for controlling the movement course comprise means for the inclusion of the detected positions of the substrate.

Preferably, configuration-specific movement sequences are recorded and stored in the form of a characteristic data set representing the respective configuration-specific movement sequence. A significantly more accurate positioning of the receiving device is possible with the aid of such characteristic data sets.

Such a characteristic data set represents, in particular, alterations of the movement sequence which are dependent on a change in the installation configuration.

In the sense of the invention, such characteristic data sets can both comprise the entire movement sequence, that is to say the parts of the data set for controlling the automation device, and merely represent the fine control of an automation device. In accordance with the second alternative, it is not necessary to record and store complete movement sequences with the associated volumes of data, rather it is possible to leave these movement courses which represent the fundamental operation of the installation. The characteristic data sets in the sense of the invention then serve merely for the fine control of the movement course.

The receiving device has, for detecting the relative position of a substrate, in one particular embodiment of the invention, at least three, preferably four and particularly preferably five sensors which enable the relative position to be determined accurately.

In addition, one or a plurality of light barriers may be provided for example for the height determination of the receiving device (Z-axis).

The method may be represented in detail as follows.

For the process sequence, firstly a parameter set for a given station is determined by the teaching of a substrate position defined with respect to the reference (teaching position).

Design data of other containers which describe the difference thereof with respect to the teaching position are then determined and stored in a database for further use.

In a next step, the handler control that controls the movement course acquires the information regarding what type of rack was established in the process. The design data stored with this type are used to correspondingly displace the teaching position and to determine a corrected station parameter set. With this altered data set, the measurement travel to be carried out is derived and initiated. The substrate positions in all degrees of freedom defined by the scope of the sensor system used arise as a result of the measurement travel.

Different corrections for various process cases can then be derived from these data:
The average values of the individual degrees of freedom can be used to correct the design data in a refined manner. If the design data are not available at this point in time, the average values can be used solely for correcting the teaching position. Substrate specific properties such as warpage, curvature, etc., such as occur in the case of very thin substrates, for example, can be concomitantly taken into account for the correction. The basic data such as the occupancy of the slots and the container specific data for fundamental trajectory planning (planning of the movement course) can now be defined and likewise used for checking whether non-correctable or undesirable incorrect positions of the substrates or of the entire container are present.
With the calculation of a local ambient value or average value of the individual degrees of freedom, the trajectory planning for an individual slot is also made dependent on the direct neighbors of said slot. Influences of position deviations of adjacent slots on the introduction or retrieval of an individual substrate can thus be determined and used for correction or for general checking for feasibility.
Slot specific correction of the individual degrees of freedom:

The determination of the position of an individual substrate can ultimately be used for the residual correction or final definition of the trajectory (movement courses) whilst taking account of the correction possibilities mentioned above.

Depending on which of the values listed above are present, these can also be applied to non-occupied slots during the process of introducing the substrate:

Should the entire container be empty, the design data can be used.

If a container is partly occupied, the average value can be used for fine correction.

In the case of reuse of the containers, which are individually identified by numbers, bar codes or other tags, the container specific measured values can be stored for future corrections as a data set and be used by correspondingly equipped installations.

Consequently, by means of the method, emptying and filling with individual trajectory planning become possible and the movement course can itself be adapted to substrate properties.

If suitable sensors are selected, these can also additionally be used for the online correction of the movement course. Since these are generally designed such that they supply expedient values only upon approaching a substrate, these should act on the individually defined data and not on the rack specific values.

The method comprises the detection, processing, application and management of design specific, individual container specific and individual slot specific position data of substrates in containers for the semiconductor industry for optimized trajectory planning of the automation technology with the purpose of increasing the process reliability and minimizing the influence of handling on the substrates during handling in or from the container.

As sensor system on the handling system, which comprises the receiving device and is part of an automation device, the following sensors may in particular be used:
distance sensors, in particular capacitive sensors at the transfer dummy oriented in the z-direction (vertically) for the position determination of heights and angles.

In this case, 6 degrees of freedom can be obtained in the case of non-rotationally symmetrical substrates such as masks, and 5 degrees of freedom can be obtained in the case of rotationally symmetrical substrates (wafers). In this case, for a process that is as fast as possible, use may be made of a z-predetermination (vertical axis), which may be effected e.g. by means of an optical sensor mounted on the substrate handler or on the container-receiving component. The capacitive sensors can also be used for an online correction.
A light beam that is interrupted can be used in order to determine distance and height information.
High-resolution distance sensors, e.g. ultrasonic sensors, oriented in the r-direction for 5 or 4 degrees of freedom. This construction produces the simplest measurement travel.

By means of the method, it is possible, with only one measurement travel, to determine all essential values in order to enable the optimum trajectory planning with respect to the best transfer position. The method enables the measurement of movement profiles between neighbors and also the approximation to the optimized transfer positions.

This results in more precise transfer positions, higher process reliability, shorter trajectory times, reduced damage (scratches, contaminations, vibrations, etc.) both when filling and when emptying the container, or the substrate repository.

The optimized trajectory determined in this method is generated in stages on the basis of design data, individual container specific data, individual slot environment data and individual slot specific data.

Through the reduction to one measurement travel, the associated loss of time is limited. The optimization of the trajectories can also lead to a time saving in the overall process.

By means of this method, design data, batch data or individual data can be determined, managed and permanently supervised.

The method permits supervision of the container data and thus enables the continuous monitoring of the container for alteration through time and use.

The use of design data and/or the deviations from the reference reduces the teaching operation to a single process and permits the use of a wide variety of types and models without additional teaching outlay.

The method permits both manual and automated transfer of the data and the assignment thereof to individual containers. The data can also be used in other systems. Through monitoring of the data, incorrect positionings of the container can be detected at an early stage, whereby the operation and process reliability is again increased.

### BRIEF DESCRIPTION OF THE DRAWINGS

The invention will be explained in more detail below with reference to the drawings in FIG. 1 to FIG. 3.

FIG. 1 schematically shows a receiving device according to the invention,

FIG. 2 schematically shows a substrate repository (rack),

FIG. 3 schematically shows a flow chart of an exemplary embodiment of the method implementation according to the invention.

### DETAILED DESCRIPTION OF THE DRAWINGS

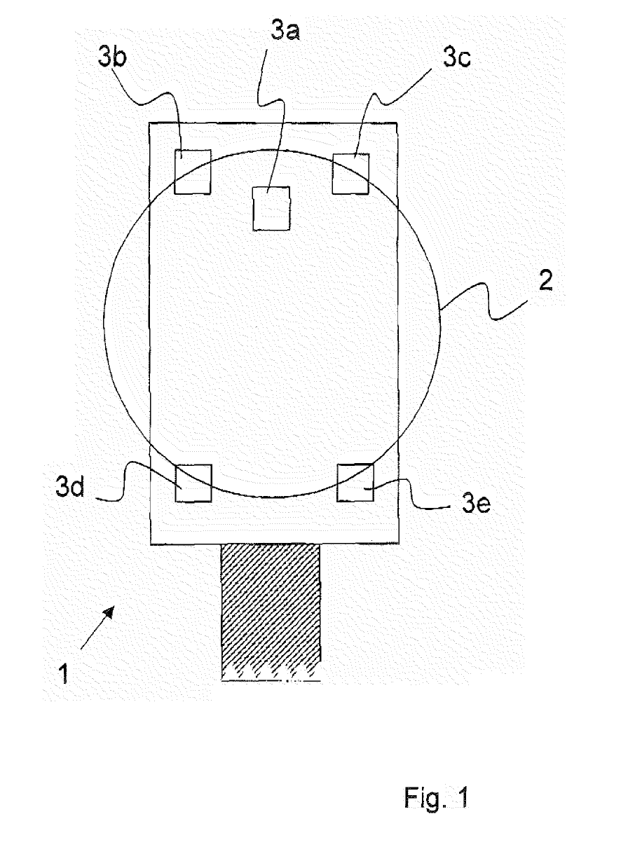

FIG. 1 schematically shows a receiving device 1 according to the invention. The receiving device 1 is embodied for receiving a substrate 2, which is illustrated schematically here in the form of a circular wafer. The substrate 5 may be received electrostatically, by way of example. The receiving device 1 is connected to an automation installation (not illustrated) and serves for receiving and transporting substrates 2.

For measuring the relative position of the substrate 2 in relation to the receiving device 1, a total of 5 sensors 3a-3e are provided on the receiving device. The sensors 3a-3e are embodied as distance sensors which effect capacitive measurement.

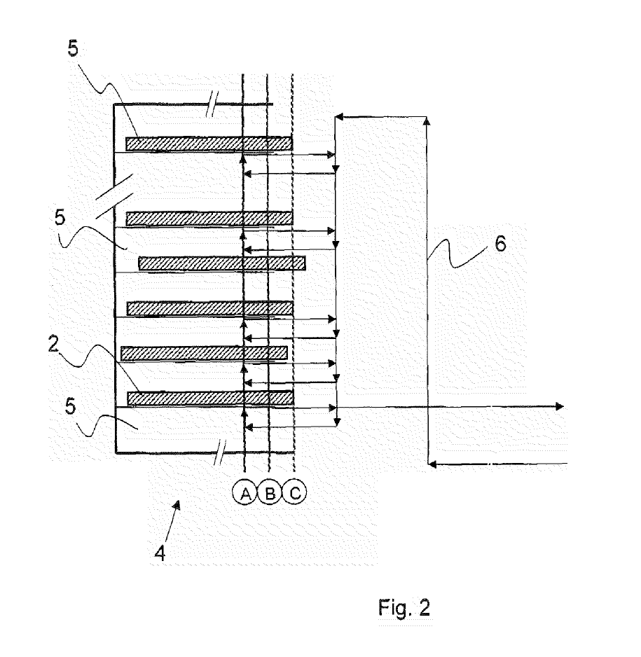

By comparing the measurement data of the sensors 3a to 3c, a determination of the relative position in all three translation directions, and also a possible tilting of the substrate at least in two rotation directions are made possible, as is explained in more detail below with reference to FIG. 2.

A measurement travel for recording data will be explained in more detail schematically referring to FIG. 2.

FIG. 2 shows a substrate repository 4, which is also referred to as a rack. The substrate repository comprises a plurality of slots 5 in which substrates 2 can be deposited.

During a measurement travel, the receiving device (not illustrated) is first raised in the z-direction, which is marked by an arrow 6, in order to be able to carry out a predetermination of the Z-axis.

This is followed by a measurement travel in which data of the sensors are recorded in order to determine the relevant data with the aid of the capacitive sensors illustrated in FIG. 1 at the measurement points which are marked by the broken lines A, B and C. In this case, the substrate receptacle follows the individual slots 5.

In position A, at least one of the sensors 3a to 3c from FIG. 1 is completely covered by the substrate. A comparison of the measured distances of the sensors 3a to 3c makes it possible to determine the height of the substrate and its possible tilting about the longitudinal axis of the receiving device.

In position B, the sensors 3a to 3c are completely covered by the substrate. By comparing the distance values between measurement points A and B, it is possible to determine a possible tilting along the transverse axis of the receiving device.

By means of the movement with respect to position C, it is possible to effect an edge determination by means of which it is possible to determine the position of the substrate in the remaining translational directions.

By means of the measurement data obtained by the sensors, it is possible first of all to store the characteristic data set, which enables for example the fine correction of the movement course in the case of different installation configurations, in particular in the case of different occupancies of the substrate repository 4. Alongside a fine setting of the movement course of the receiving device during a learning travel, the movement course can also be corrected further during the operation of the installation continuously either with consultation of further characteristic data obtained during further measurement travels and/or whilst continuously taking account of the sensor measured values.

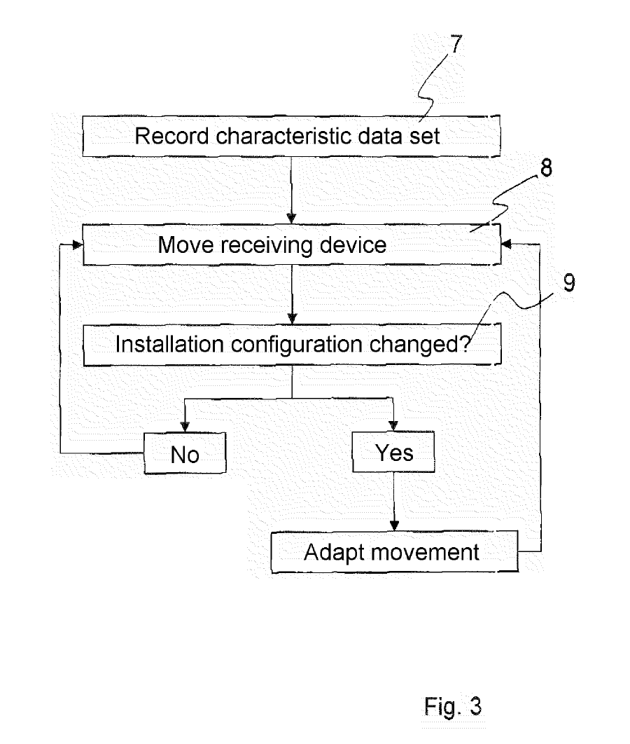

FIG. 3 schematically shows a flow chart of the essential method steps of an embodiment of the method according to the invention.

Firstly, one or a plurality of characteristic data sets are recorded 7 in a learning travel.

The receiving apparatus integrated in the automation device (not illustrated) can then be moved 8 for the purpose of carrying out production steps. After a movement course for example after a substrate has been received and passed on, a check is made to ascertain whether the installation configuration has changed 9. By way of example, it is possible to determine on the basis of a bar code on a substrate repository whether a new substrate repository has been inserted into the installation. If the installation configuration is not changed, the method jumps back to the step move receiving apparatus 8. The receiving device is moved in the manner corresponding to the characteristic data set at present.

If the installation configuration has changed, the movement of the receiving device is adapted to the changed installation configuration by a new stored characteristic data set being read in. In this case, the stored characteristic data set represents the change in the movement sequence for the purpose of fine setting. At the same time, a continuous adaptation can be performed continuously by means of sensors of the receiving device. In this case, it is also possible, in particular, to record and store new characteristic data sets corresponding to changed installation configurations.

It goes without saying that the present invention is not restricted to a combination of features described above, rather that the person skilled in the art will combine the described features as desired insofar as is expedient.

What is claimed is:

1. A method for receiving and/or transporting substrates comprising:
detecting, by means of at least one sensor, a position of a substrate, at least with respect to one degree of freedom; and
determining a movement course of at least one of a receiving device and a transporting device with the inclusion of said position.

2. The method of claim 1, wherein the relative position of said substrate with respect to said receiving device is determined by means of the at least one sensor.

3. The method of claim 1, wherein the occupancy of a substrate repository is determined by means of at least one sensor.

4. The method of claim 1, wherein a position of at least one of said substrate and the occupancy of a substrate repository is determined by means of at least one sensor arranged on said receiving device.

5. The method of claim 1, wherein characteristic data relating to position changes are stored and the movement course is determined with inclusion of said characteristic data.

6. The method of claim 1, wherein at least one characteristic data set is recorded and/or stored which represents changes in the movement course which are dependent on a change in the installation configuration.

7. The method of claim 1, wherein a fine setting of the movement course is determined by means of the determination of position changes.

8. The method of claim 1, wherein the movement course of the at least one of the receiving device and the transporting device is determined in a learning cycle.

9. The method of claim 1, wherein the movement course is adapted to changed installation configurations continuously or at intervals.

10. The method of claim 1, wherein the occupancy of a container with respect to the substrate repository and/or the type of a substrate to be moved is taken into account in the determination of the movement course of the receiving device and/or transporting device.

11. The method of claim 1, wherein the relative position of a substrate with respect to a substrate receiving device is determined as the position.

12. The method of claim 1, wherein installation-, in particular container-specific characteristic data sets are stored in a database and used for determining the movement course of the at least one receiving and/or transporting device.

13. The method of claim 1, wherein the position of the substrate is detected in three translation directions.

14. The method of claim 1, wherein the position is detected in at least two rotation directions.

15. The method of claim 1, wherein the position is detected by means of at least two sensors arranged on a receiving device.

16. The method of claim 15, wherein capacitive sensors are provided as the sensors.

17. The method of claim 16, wherein data which represent at least one movement operation are stored in a memory.

18. An apparatus for receiving and/or transporting substrates, comprising:
at least one sensor for detecting the position of a substrate at least with respect to one degree of freedom; and
means for controlling a movement course of at least one of a receiving device and a transporting device for substrates, wherein the means for controlling the movement course comprise means for the inclusion of the detected position of the substrate.

19. The apparatus of claim 18, wherein the apparatus comprises means for recording and/or storing at least one characteristic data set which represents a configuration-specific movement sequence.

20. The apparatus of claim 18, wherein the apparatus has means for adapting the movement course depending on an alteration of the installation configuration.

21. The apparatus of claim 20, wherein the characteristic data set represents an alteration of the movement course depending on a change in the installation.

22. The apparatus of claim 18, wherein the apparatus comprises means for recording and/or storing at least one characteristic data set which represents the fine control of the movement course.

23. The apparatus claim 22, wherein the apparatus comprises means for the fine control of the movement course with the inclusion of said position.

24. The apparatus of claim 18, wherein the apparatus has, for distance measurement, at least one of a capacitive sensor, an ultrasonic sensor and a light barrier.

25. The apparatus of claim 18, wherein the apparatus has a receiving device which has at least three sensors.

26. An automation device comprising an apparatus for receiving and/or transporting substrates as claimed in claim 18.
